(19) United States
(12) Patent Application Publication
(10) Pub. No.: US 2007/0039334 A1
(43) Pub. Date: Feb. 22, 2007

(54) Avatar refrigerator and control method thereof

(75) Inventor: Hwan Suk Hong, Gyeongsangnam-do (KR)

Correspondence Address: FLESHNER & KIM, LLP, P.O. BOX 221200, CHANTILLY, VA, 20153, US

(73) Assignee: LG Electronics Inc.

(21) Appl. No.: 11/505,455

(22) Filed: Aug. 17, 2006

(30) Foreign Application Priority Data
Aug. 18, 2005 (KR) P2005-0075773

(51) Int. Cl. G01K 13/00; F25D 11/02

(52) U.S. Cl. 62/129; 62/441

(57) ABSTRACT

An object of the present invention is to provide a refrigerator of a new concept, which improves a user interface convenience for providing a variety of contents to the user other than the long time storage function of the related art refrigerator, and enables the user to make easy contact to the contents. The object of the present invention can be achieved by providing an avatar refrigerator including a body having a freezing chamber and a refrigerating chamber, a door on the body for opening/closing the freezing chamber and the refrigerating chamber, and a contents provider mounted on the door for providing contents for modes of an avatar set up mode, a temperature control mode, a learning mode, and a game mode, together with an avatar.

### CROSS-REFERENCE TO RELATED APPLICATION

This application claims the benefit of Korean Application No. P2005-0075773 filed on Aug. 18, 2005, which is hereby incorporated by reference as if fully set forth herein.

### BACKGROUND OF THE INVENTION

1. Field of the Invention

The present invention relates to refrigerators for cold storage of food or the like, and more particularly, to an avatar refrigerator of a new concept which overcomes a traditional concept of a related art refrigerator that has functions of cold storage or frozen storage of food or the like only, to enable a user to contact with various contents, such as education, culture, multimedia, and so on, through the refrigerator.

2. Discussion of the Related Art

In general, the refrigerator, for maintaining a freezing chamber and a refrigerating chamber at a low temperature by using cold air to make fresh storage of food at the low temperature, is provided with a refrigerating cycle having, as basic units, a compressor for compressing refrigerant to high temperature, high pressure gaseous refrigerant, a condenser for condensing the refrigerant passed through the compressor to liquid refrigerant of middle pressure, and high temperature, an expansion valve for expanding the refrigerant passed through the condenser, and an evaporator for evaporating the refrigerant passed through the expansion valve to gaseous refrigerant of low temperature, and low pressure, to absorb heat from the freezing chamber or the refrigerating chamber to maintain the freezing chamber or the refrigerating chamber at a low temperature.

Currently, as an area the refrigerator occupies in a residential space becomes greater following appearance of large sized refrigerators, such as side by side type refrigerators, and a consumer trend preferring the large sized refrigerators of high quality images prevails, various kinds refrigerators having a variety of functions are on demand.

Accordingly, it becomes a core technology, not that the refrigerator simply performs only function of long time conservation of food as usual, but that the refrigerator is added with new functions, for an example, a middle, or large sized refrigerator is provided with a dispenser to have a function for dispensing ice or cold water.

Therefore, since the refrigerator can be installed anywhere of a living room or kitchen, and a ratio of occupancy of the refrigerator is very large in a residential space as the size of the refrigerator becomes greater gradually, the refrigerator is suitable for providing the variety of cultural contents, and meets the recent trend of adding new functions to the refrigerator. That is, development of, not a related art refrigerator for simple long time storage, but a refrigerator of a new concept for providing a variety of contents in addition to the long time storage, is required.

### SUMMARY OF THE INVENTION

Accordingly, the present invention is directed to an avatar refrigerator that substantially obviates one or more problems due to limitations and disadvantages of the related art.

An object of the present invention is to provide a refrigerator of a new concept, which improves a user interface convenience for providing a variety of contents to the user other than the long time storage function of the related art refrigerator, and enables the user to make easy contact to the contents.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an avatar refrigerator includes a body having a freezing chamber and a refrigerating chamber, a door on the body for opening/closing the freezing chamber and the refrigerating chamber, and a contents provider mounted on the door for providing contents for modes of an avatar set up mode, a temperature control mode, a learning mode, and a game mode, together with an avatar.

The contents provider includes an input unit for the user to input predetermined information, a storage unit for storing data including information on the avatar, information on contents of each of the modes, predetermined information the user inputs, information on step of progress of each mode, a display unit for displaying the data stored in the storage unit in a form the user can understand, together with the avatar, and a control unit for controlling information input by the input unit, storage of data to the storage unit, and processing of the data stored in the storage unit and displaying of the data on the display unit.

The contents provider further includes a communication unit for accessing to a predetermined education information server, downloading predetermined learning data information, and storing the learning data information in the storage unit.

The input unit includes a mode selection portion adjacent to the display unit, formed of input buttons for each mode

The input unit includes an avatar set up mode selection window, a temperature control mode selection window, a learning mode selection window, and a game mode selection window.

The input unit includes personal information input windows, including a name input window, a sex input window, an age input window, a school carrier input window, a learning field input window, and a learning difficulty index input window.

The input unit includes a face selection window, a hair style selection window, a coat selection window, a trousers selection window, and an accessory selection window.

In another aspect of the present invention, a method for controlling an avatar refrigerator including (A) a step for selecting a mode, (B) a step for providing a learning data and a learning progress suitable to a personal level according to personal information inputted under guidance of an avatar, if a learning mode is selected, and (C) a step for storing the learning progress under proceeding and ending the learning mode, if the learning mode ends.

The (B) step comprises a step for determining if there is personal information of the user stored, a step for displaying personal information input windows for the user to input personal information including a name, sex, age, school carrier, learning field, and a learning difficulty index, if there is no stored personal information of the user, and a step for storing the personal information and setting up a learning data and a learning progress suitable to a learner's level according the to the personal information.

The (B) step comprises a step for determining if there is the personal information of the user stored, and a step for progressing learning according to the learning progress stored under the guidance of the avatar, if there is the personal information of the user stored.

The method for controlling the avatar refrigerator, if a temperature control mode is selected in the (A) step, further includes (D) a step for displaying information on the present set up temperature and enabling to change the information on the present set up temperature under the guidance of the avatar.

The (D) step includes a step for determining if there is change of the set up temperature, a step for storing a set up temperature inputted, if there is change of the set up temperature, and a step for controlling a cooler according to the changed set up temperature.

The method for controlling the avatar refrigerator, if a game mode is selected in the (A) step, further includes (E) a step for selecting a game under the guidance of the avatar and put into the selected game into action continuous from an existing stored portion, or starting from beginning, and (F) a step for storing game information under playing and ending the game mode, if the game mode ends.

The (E) step includes a step for determining if there is information on the selected game stored, a step for determining if the stored game is played continuously and playing the selected game starting from beginning or continuously according to a result of the determination, if there is the information on the selected game stored, and a step for playing the selected game starting from beginning, if there is no game information stored.

The method for controlling the avatar refrigerator, if an avatar set up mode is selected in the (A) step, further includes (G) a step for setting up the avatar, and (H) a step for storing the information on the set up avatar.

The (G) step includes (I) a step for determining if there is information on the avatar of the user stored, (J) a step for displaying a window for selecting or inputting information on the avatar including a face, a hair style, a coat, trousers, and accessories of the avatar, if there is not the information on the avatar stored, and (K) a step for displaying the information on the avatar stored, if there is the information on the avatar stored.

The (K) step includes a step for determining if the information on the avatar stored changes, a step for displaying a window for selecting or inputting information on the avatar including a face, a hair style, a coat, trousers, and accessories of the avatar, if the information on the avatar changes, and a step for storing the information on the avatar selected or inputted thus.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a front view of an avatar refrigerator in accordance with a preferred embodiment of the present invention;

FIG. 2 illustrates a block diagram of a control system of an avatar refrigerator of the present invention; and

FIGS. 3 and 4 illustrate a flow chart showing the steps of a method for controlling an avatar refrigerator in accordance with a preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

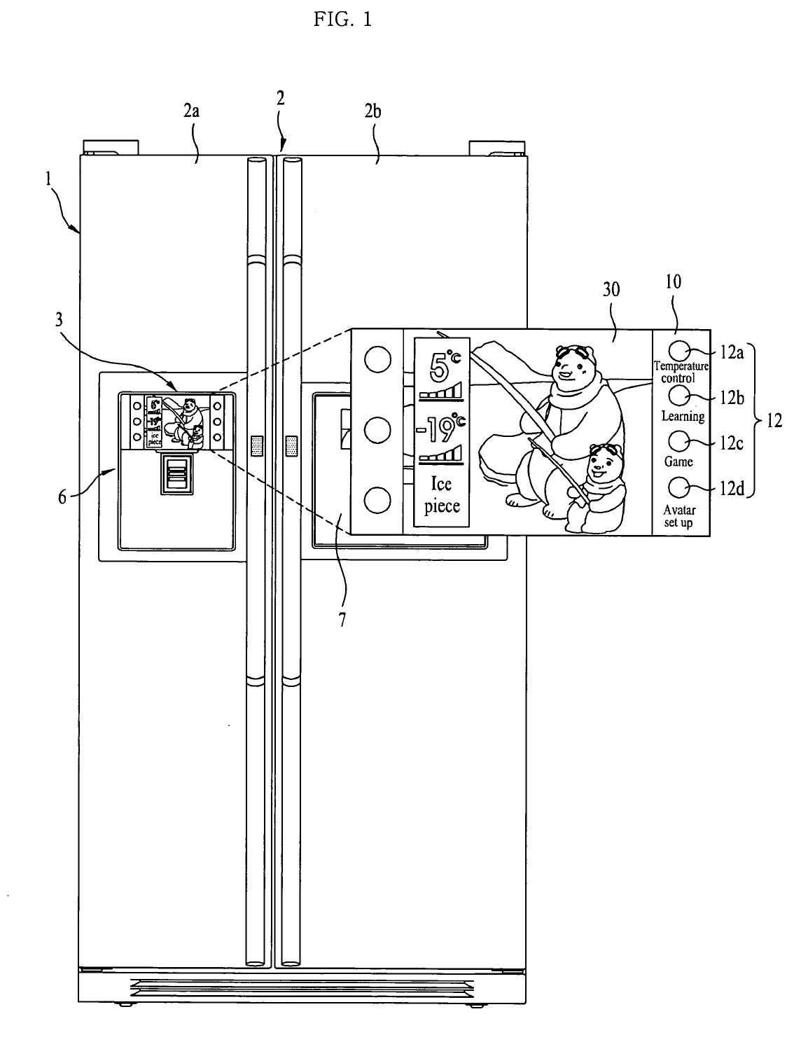

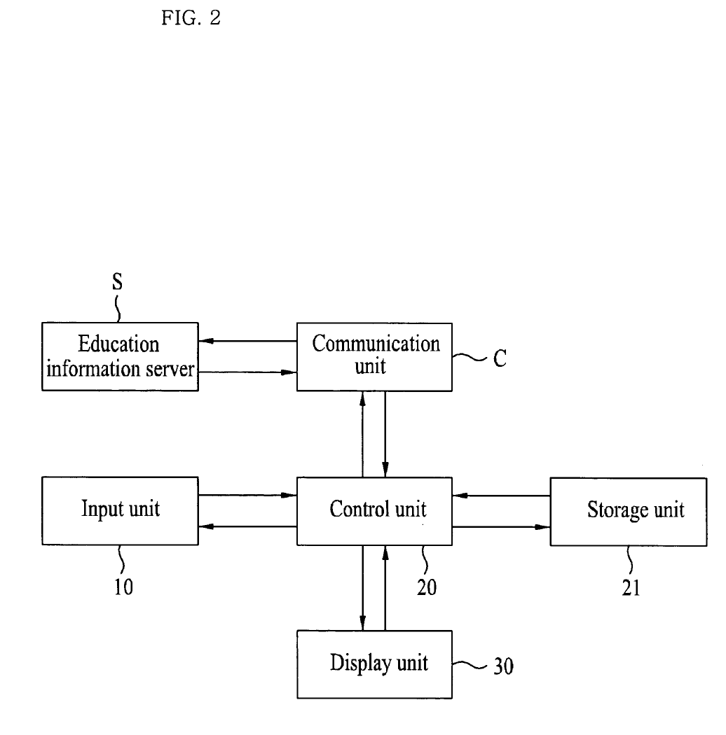

FIG. 1 illustrates a front view of an avatar refrigerator in accordance with a preferred embodiment of the present invention, and FIG. 2 illustrates a block diagram of a control system of an avatar refrigerator of the present invention.

Referring to FIG. 1, the avatar refrigerator in accordance with a preferred embodiment of the present invention includes a body 1 of an entire outside shell thereof, and doors 2 for opening/closing a refrigerating chamber (not shown) and a freezing chamber (not shown).

The door 2 includes a freezing chamber door 2a and a refrigerating chamber door 2b, wherein the freezing chamber door 2a has a dispenser 6 provided to one side for dispensing ice or cold water, and the refrigerating chamber door 2b has a home bar 7 provided to one side for making easy use of drinks or the like stored therein.

In the meantime, the freezing chamber door 2a is provided with a contents provider 3 for providing a variety of contents to the user. The contents provider 3 has a variety of contents providing modes for providing predetermined contents to the user according to selection of a mode. Particularly, by providing the predetermined contents through an avatar, to induce user's interest thereto and let the user concentrate thereon naturally, the contents provider 3 improves convenience of a user interface, or the like.

Referring to FIG. 1, in an embodiment of the present invention, the contents provider 3 in the avatar refrigerator 3 of the present invention provides four contents modes of an avatar set up mode, a temperature control mode, a learning mode, and a game mode.

The modes can be put into operation by personal selection of the user through an input unit 10 in the contents provider 3, and the user can be provided with required contents through the display unit 30 of the contents provider 3. As shown in FIG. 1, the input unit 10 has a mode selection portion 12 adjacent to the display unit 30 with buttons 12a, 12b, 12c, and 12d for selection of the modes, personally.

Though the user can select a desired mode through the mode selection portion 12, the mode can also be selected through a selection window displayed on the display unit 30 instead of the mode selection portion 12. That is, if the display unit 30 is fabricated of a touch screen, the user can select the desired mode by touching the display unit 30 personally, wherein the input unit 10 may have an avatar set up mode selection window, a temperature control mode selection window, a learning mode selection window, and a game mode selection window at the display unit 30 instead of the mode selection portion 12, so that all the modes of selection windows are displayed on the display unit for the user to touch one of the modes to select the desired mode. Besides the mode selection portion 12 shown in FIG. 1, the input unit includes all means for inputting information through various selection or input windows displayed on the display unit 30 of the touch screen type.

The contents provider 3 will be described with reference to FIG. 2.

Referring to FIG. 2, the contents provider of the avatar refrigerator of the present invention includes the input unit 10 for the user to input required information, and a storage unit 21 for storing data containing information on the avatar, information on contents of the modes, information the user inputs, and information progress steps of each of the modes.

The contents provider also includes the display unit 30 for displaying the data in the storage unit in a form the user can notice together with the avatar, and a control unit 20 for controlling reception of information from the input unit 10, storage of data to the storage unit 21, and processing of the data stored in the storage unit 21 to display on the display unit 30.

The storage unit 21 has all data stored therein for enabling the user to receive desired contents in a desired mode. Therefore, if the user inputs information through the input unit 10, the control unit 20 reads the data stored in the storage unit 21, turns the data in a form the user can understand easily, and display on the display unit 30, thereby providing the desired contents.

In this instance, by taking a form in which the control unit 20 displays an animation character of called an avatar that acts on behalf of the user in a virtual space, and the avatar provides the contents the user desires, the user can be provided with the contents with interest.

In the meantime, the contents provider further includes a communication unit C for access to a required server through transmission/reception of a wire, or wireless signal, and transmission/reception of required information, for the user to enable access to various kinds of contents. Accordingly, the user may access to a server that provides the required contents, like an education information server S, and download/upload a desired data.

The operations and functions of the contents provider that is to provide contents for each of the modes will be described.

The user can set up the avatar that represents the user in the virtual space in a form the user desires. This can be achieved through the avatar set up mode which can be put into operation either by pressing the avatar set up mode button (12a, see FIG. 1) on the mode selection portion of the input unit 10, or, though not shown, by selecting the avatar set up mode selection window displayed on the display unit 30.

In the avatar set up mode, avatar input windows, such as a face selection window, a hair style selection window, a coat selection window, a trousers selection window, an accessory selection window, and so on, are displayed on the display unit in succession or at the same time for displaying various kinds of information on various shapes of faces, hair styles, clothes, accessories, and so on of the avatar, and the user selects desired ones from each of items through the touch screen, to complete the avatar by combining the selected items. Information on the avatar may also be downloaded through a server accessed thereto through the communication unit.

The control unit stores the information on the avatar formed through the avatar input window in the storage unit, and in a case the same user uses the contents provider again, and makes to perform the modes by displaying the stored avatar, and performing the modes according to guide of the avatar.

In the meantime, the user can control a temperature of a chamber of the refrigerator through the contents provider. That is, upon selection of the temperature control button (12b, see FIG. 1) of the mode selection portion, or a temperature control mode on the temperature control mode selection window in the mode selection window displayed on the display unit, a preset avatar is displayed, and indicates information on the present temperature of the refrigerator.

The user may change the temperature set presently, and the control unit controls a cooler (though in general an evaporator is used, a thermoelement or the like may be used) in the refrigerator according to the set temperature, to control at least one of the refrigerating chamber and the freezing chamber.

In the meantime, the user may obtain information on a desired learning data trough the learning mode the contents provider provides. When the user selects the learning mode selection button (12c, see FIG. 1) of the mode selection portion, or a learning mode on the learning mode selection window displayed on the display unit, a preset avatar is displayed, and provides the learning data to the user.

That is, when the user puts the learning mode into action, personal information input windows, such as a name input window, a sex input window, an age input window, a school carrier input window, a learning field input window, learning difficulty index input window, and so on, are displayed for the user to input personal information, such as a name, sex, age, school carrier, a learning field, a learning difficulty index, and so on. In this instance, the avatar guides input to the windows.

Upon finishing the input following the guide of the avatar for the items of the personal information input windows, the control unit stores the personal information inputted thus, sets up a learning data and learning progress suitable to a level of the learner, and provides the user with a required learning data suitable to the set up learning progress through media, such as text, picture, motion picture, sound, and so on. In this instance, the control unit controls the avatar to provide the required learning data suitable to the learning progress set up through the media. Moreover, the control unit may download an appropriate learning data through the educational information server (S, see FIG. 2) accessed by the communication unit.

If the user ends the learning mode, and puts the learning mode into action again later, it is designed that the user performs learning in succession to the learning progress proceeded before according to the personal information stored already.

In the meantime, the user may play various games in the game mode. If the game mode selection button 12d (see FIG. 1) of the mode selection portion, or the game mode selection window displayed on the display unit is pressed, a selection window is displayed on the display unit for selecting various kind of games, and, if the user selects one of the games, the selected game is put into action. The game may be put into action from a beginning, or, if there is a portion put into action before, but stopped in the middle, the game may be put into action from a portion after the stopped portion.

A method for controlling an avatar refrigerator having the foregoing contents provider applied thereto will be described.

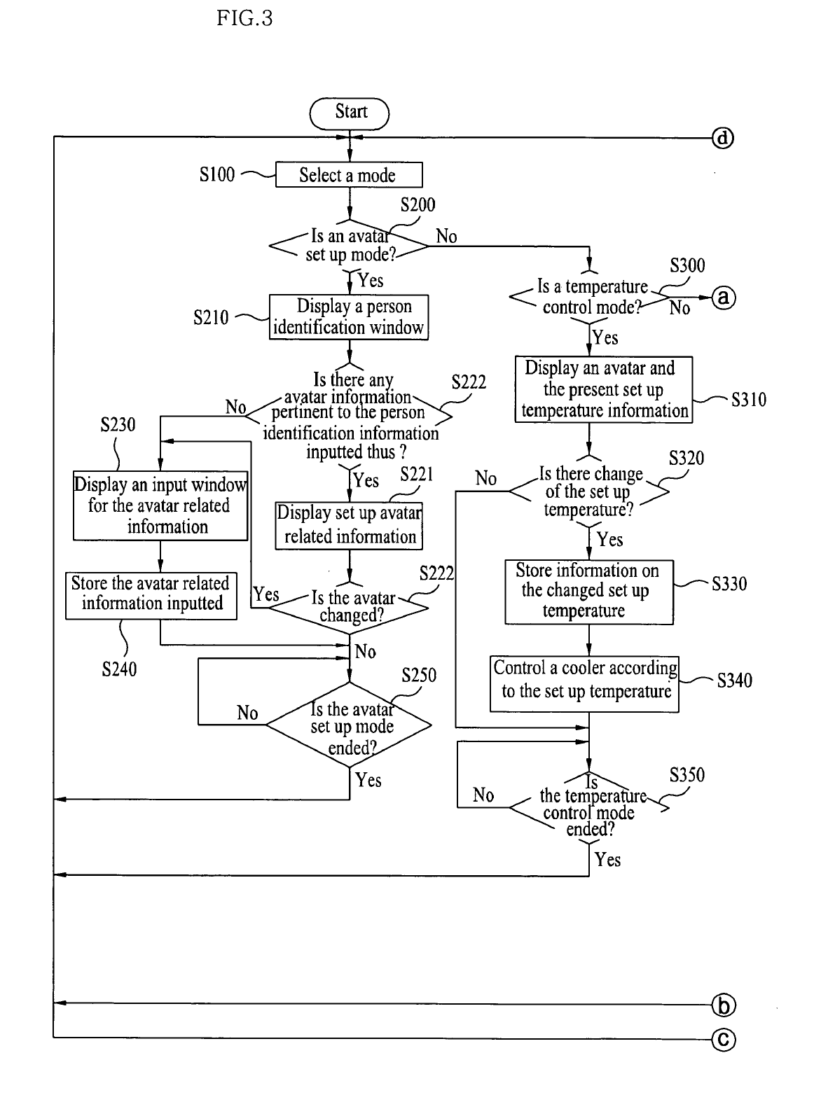

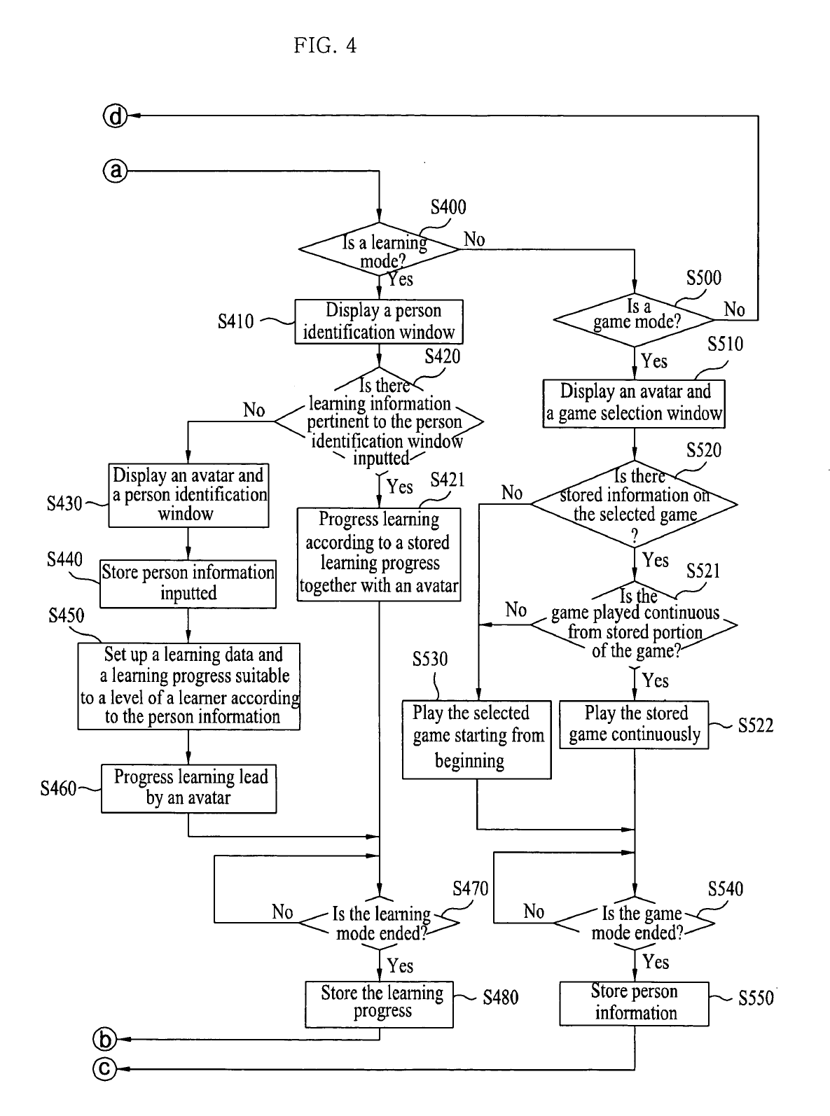

FIGS. 3 and 4 illustrate a flow chart showing the steps of a method for controlling an avatar refrigerator in accordance with a preferred embodiment of the present invention. \textcircled{a}, \textcircled{b}, \textcircled{c}, and \textcircled{d} at ends of signal flows in FIG. 3 are continuous to \textcircled{a}, \textcircled{b}, \textcircled{c}, and \textcircled{d} at ends of signal flows in FIG. 4, respectively.

The user selects a desired mode through the input unit of the contents provider (S100).

If there is a selection of mode, the control unit determines whether the selection of mode is the avatar set up mode (S200), the temperature control mode (S300), the learning mode (S400), or the game mode (S500), and put the selected mode into action.

If the avatar set up mode is put into action, the control unit displays a person identification window (S210) including, for an example, a name input window. That is, the person identification window is displayed to let the user input simple personal information, such as a user's name, for finding avatar information pertinent to the name.

If there is an input of the simple personal information to the person identification window, the control unit determines if there is avatar information pertinent to the person identification information (S220). If there is, entire avatar related information set up before is displayed (S221). If there is no avatar information pertinent to the person identification information, the control unit displays an avatar related information input window for displaying various kinds of information on various face shapes, hair styles, clothes, and accessories of the avatar (S230), and stores avatar related information inputted accordingly (S240).

If there is avatar related information set already, if the user desires to change the present avatar, the avatar related information may be changed (S222). In a case the avatar related information is changed, the S230 step and the S240 step are performed again.

If the user touches an end selection window, or an end button provided on an outside of avatar refrigerator, the avatar set up mode ends (S250), and the process returns to the mode selection step (S100) again.

If the temperature control mode is put into action, the control unit displays a preset avatar, and displays information on the present chamber temperatures of the refrigerating chamber and the freezing chamber in a fashion guided by the avatar (S310).

The user can change information on the temperatures set up presently, in which the control unit determines if there is change on the set up temperature (S320), and, if there is newly inputted information on the changed temperature, stores the temperature information (S330), and controls the cooler according to the set temperature (S340).

The temperature control mode can be ended through the end selection window or the end button (S350), and if the temperature control mode ends, the process returns to the S100 step, again.

In the meantime, if the learning mode is put into action, the control unit displays the person identification window (S410) including, for an example, a name input window for inputting a name. That is, the person identification window is displayed to let the user input simple personal information, such as a user's name, for finding avatar information pertinent to the name.

If there is an input of the simple personal information to the person identification window, the control unit determines if there is learning information pertinent to the person identification information (S420). If there is the learning information pertinent to the person identification information stored in a storage unit, the control unit provides a learning data suitable to a learning progress of the learning information stored in the storage unit through multimedia, such as text, image, motion picture, sound, and so on, and displays the avatar to progress or guide the process, thereby progressing the learning (S421).

If there is no avatar information pertinent to the person identification information, the control unit displays a window for the user to input the present personal information thereon. That is, a window is displayed with an avatar thereon for guiding input of personal information input windows, for an example, the present user's name, sex, age, school carrier, learning field, learning difficulty index, and so on (S430).

When the user inputs the personal information, the control unit stores the personal information in the storage unit (S440), and sets up a learning data and a learning progress suitable to a level of the person according to the personal information inputted thus (S450). Then, according to proceeding of the avatar, the set up learning data is provided to the user according to the set up learning progress (S460).

If the user presses an end button, or an end window, the control unit stores information on a progress of learning proceeding presently (S480), ends the learning mode (S470), and returns to the S100 step again.

If a game mode is selected, the control unit displays a game selection window together with the avatar (S510). If a game is selected by the user, the game is put into action. In this instance, the control unit determines if there is information on the selected game (S520), and, if there is information on the game stored, determines if the game will be played in succession (S521).

In a case the user going to play the game in succession, the game is played in continuation from a portion of the game stored previously (S522), and, if the user intends to play the game stored from beginning, the game is put into action from the beginning (S530).

If the user presses a game end button, or an end selection window, the control unit determines if the game mode is to be put to an end (S540). If the game mode is to be put to an end, the control unit stores game information (S550), ends the game mode, and returns to the S100 step.

The avatar refrigerator, and the method for controlling the same of the present invention can provides various kinds of contents, such as education, multimedia, game, and so on, in addition to cold, and frozen storage of food, can secure user interface convenience by providing the contents through an avatar, and, particularly, in the case of the educational contents, permits to perform learning suitable to a personal level.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An avatar refrigerator comprising:
a body having a freezing chamber and a refrigerating chamber;
a door on the body for opening/closing the freezing chamber and the refrigerating chamber; and
a contents provider mounted on the door for providing contents for modes having an avatar set up mode, a temperature control mode, a learning mode, and a game mode, together with an avatar.

2. The avatar refrigerator as claimed in claim 1, wherein the contents provider comprises:
an input unit for the user to input predetermined information,
a storage unit for storing data having information on the avatar, information on contents of each of the modes, predetermined information the user inputs, information on step of progress of each mode,
a display unit for displaying the data stored in the storage unit in a form the user can understand, together with the avatar, and
a control unit for controlling information input by the input unit, storage of data to the storage unit, and processing of the data stored in the storage unit and displaying of the data on the display unit.

3. The avatar refrigerator as claimed in claim 2, wherein the contents provider further comprises a communication unit for accessing to a predetermined education information server, downloading predetermined learning data information, and storing the learning data information in the storage unit.

4. The avatar refrigerator as claimed in claim 2, wherein the input unit comprises a mode selection portion adjacent to the display unit, formed of input buttons for each mode.

5. The avatar refrigerator as claimed in claim 2, wherein the input unit comprises an avatar set up mode selection window, a temperature control mode selection window, a learning mode selection window, and a game mode selection window.

6. The avatar refrigerator as claimed in claim 2, wherein the input unit comprises personal information input windows, the personal information input windows comprising:
a name input window, a sex input window, an age input window, a school carrier input window, a learning field input window, and a learning difficulty index input window.

7. The avatar refrigerator as claimed in claim 2, wherein the input unit comprises avatar input windows, the avatar input windows comprising:
a face selection window, a hair style selection window, a coat selection window, a trousers selection window, and an accessory selection window.

8. A method for controlling an avatar refrigerator comprising:
(A) a step for selecting a mode;
(B) a step for providing a learning data and a learning progress suitable to a personal level according to personal information inputted under guidance of an avatar, if a learning mode is selected; and
(C) a step for storing the learning progress under proceeding and ending the learning mode, if the learning mode ends.

9. The method as claimed in claim 8, wherein the (B) step comprises:
a step for determining if there is personal information of the user stored;
a step for displaying personal information input windows for the user to input personal information including a name, sex, age, school carrier, learning field, and a learning difficulty index, if there is no stored personal information of the user; and
a step for storing the personal information and setting up a learning data and a learning progress suitable to a learner's level according the to the personal information.

10. The method as claimed in claim 8, wherein the (B) step comprises:
a step for determining if there is the personal information of the user stored, and a step for progressing learning according to the learning progress stored under the guidance of the avatar, if there is the personal information of the user stored.

11. The method as claimed in claim 8, if a temperature control mode is selected in the (A) step, further comprising,
(D) a step for displaying information on the present set up temperature and enabling to change the information on the present set up temperature under the guidance of the avatar.

12. The method as claimed in claim 11, wherein the (D) step comprises:
a step for determining if there is change of the set up temperature;
a step for storing a set up temperature inputted, if there is change of the set up temperature; and
a step for controlling a cooler according to the changed set up temperature.

13. The method as claimed in claim 8, if a game mode is selected in the (A) step, further comprising:
(E) a step for selecting a game under the guidance of the avatar and put into the selected game into action continuous from an existing stored portion, or starting from beginning; and
(F) a step for storing game information under playing and ending the game mode, if the game mode ends.

14. The method as claimed in claim 13, wherein the (E) step comprises:
a step for determining if there is information on the selected game stored;
a step for determining if the stored game is played continuously and playing the selected game starting from beginning or continuously according to a result of the determination, if there is the information on the selected game stored; and
a step for playing the selected game starting from beginning, if there is no game information stored.

15. The method as claimed in claim 8, if an avatar set up mode is selected in the (A) step, further comprising:
(G) a step for setting up the avatar, and
(H) a step for storing the information on the set up avatar.

16. The method as claimed in claim 15, wherein the (G) step comprises:
(I) a step for determining if there is information on the avatar of the user stored;
(J) a step for displaying a window for selecting or inputting information on the avatar including a face, a hair style, a coat, trousers, and accessories of the avatar, if there is not the information on the avatar stored; and
(K) a step for displaying the information on the avatar stored, if there is the information on the avatar stored.

17. The method as claimed in claim 16, wherein the (K) step comprises:
a step for determining if the information on the avatar stored changes;
a step for displaying a window for selecting or inputting information on the avatar including a face, a hair style, a coat, trousers, and accessories of the avatar, if the information on the avatar changes; and
a step for storing the information on the avatar selected or inputted thus.
